(19) United States
(12) Patent Application Publication
(10) Pub. No.: US 2003/0093358 A1
(43) Pub. Date: May 15, 2003

(54) System and method for processing invoice of exported product

(75) Inventors: Ying-Ming Liao, Taipei (TW); Yun-Chi Lee, Taipei (TW); Wen-Yi Chang, Taipei (TW)

Correspondence Address: Peter F. Corless, EDWARDS & ANGELL, LLP, 101 Federal Street, Boston, MA, 02110, US

(73) Assignee: Inventec Corporation

(21) Appl. No.: 09/993,032

(22) Filed: Nov. 14, 2001

(51) Int. Cl. G06F 17/60

(52) U.S. Cl. 705/37

(57) ABSTRACT

A system and a method for processing an invoice of exported products are proposed, allowing a manufacturer that is ready to export products to immediately transmit invoice and packing data of the exported products through a network communication system to a forwarder company and a custom broker, so as to construct exportation associated documents. This therefore saves time consumed in invoice data printing and posting, and makes the manufacturer more efficiently interact with the forwarder company and the custom broker. In addition, the foregoing system and method for processing an invoice of exported products eliminate the use of manual printing or delivering the invoice and packing data of the exported products, so that the manufacturer can effectively save human resources. Therefore, the invention is advanced and practicable.

### FIELD OF THE INVENTION

The present invention relates to systems and methods for processing invoices of exported products, and more particularly, to a system and a method for processing an invoice of exported products, in which associated data of exported products from a manufacturer can be immediately transmitted to a forwarder company and a custom broker, so as to make associated export documents as required.

### BACKGROUND OF INVENTION

For a manufacturer seeking for international business, a conventional process for exporting product is illustrated in FIG. 1, in which when products are ready to be exported, first in step S10, an exportation workstation of the manufacturer establishes exportation data files according to the exported products, and stores the data files in an internal database of the manufacturer.

Then in step S11, the exportation workstation constructs dedicated invoice data respectively for the exportation data files.

Next in step S12, the exportation workstation prints out the invoice data, and then faxes or posts the invoice data to a forwarder company and a custom broker.

However, the foregoing process for exporting products is defective in that, when the manufacturer is ready to export products, the above step S12 for printing and delivering the invoice data is manually implemented. Such a manual procedure is therefore relatively time-ineffective, and delays time for the forwarder company and the custom broker to receive the invoice data, thereby making time of product exportation undesirably prolonged.

Therefore, it is critical to provide an internationalization manufacturer with a novel system and method for processing invoices of exported products, allowing a forwarder company and a custom broker to immediately obtain the invoices; this not only makes the communication between the two parties more efficient, but also shortens time for exporting the products.

### SUMMARY OF THE INVENTION

A primary objective of the present invention is to provide a system and a method for processing an invoice of exported products, in which dedicated invoice data of exported products can be immediately transmitted to a forwarder company and a custom broker.

Another objective of the invention is to provide a system and a method for processing an invoice of exported products, in which invoice data of exported products are not necessary to be manually printed and delivered, so that human resources are saved, and time of product exportation is shortened.

In accordance with the foregoing and other objectives, the present invention proposes a system and a method for processing an invoice of exported products.

The system for processing an invoice of exported products of the invention comprises: an exportation database for storing an exportation data file of exported products established by a manufacturer; an EDI (electronic data interchange) platform for converting format of the exportation data file stored in the exportation database into web page standard format, and for assigning the converted exportation data file with an invoice number, an invoice date and a pick-up number, so as to establish a corresponding invoice data file; an invoice database for storing the invoice data file established by the EDI platform; and a website server for publishing the invoice data file stored in the invoice database to the website server, so as to allow a forwarder company or a custom broker to browse the invoice data file published by the website server through Internet.

The method for processing an invoice of exported products of the invention, in the use of the foregoing system for processing an invoice of exported products, comprises the steps as follows. First, when a manufacturer is ready to export products, an exportation data file is established for the exported products by the manufacturer and transmitted to the exportation database of the invoice processing system for storage, wherein a category number and a serial number of the exported products are used as an identification number of the exportation data file, allowing an exportation workstation to retrieve the exportation data file and attach exportation data to the exported products. Next, the EDI platform converts the exportation data file stored in the exportation database from document format into web page standard format. Then, the EDI platform assigns the converted exportation data file with an invoice number, an invoice date and a pick-up number, so as to establish an invoice data file dedicated for the exported products, and store the invoice data file in the invoice database. Finally, a website server publishes the invoice data file stored in the invoice database, allowing a forwarder company or a custom broker to browse the invoice data file published by the website server through a network communication system, so as to retrieve associated invoice data corresponding to the category number and the serial number of the invoice data attached to the exported products, and to make associated documents for product exportation.

In the use of the system and method for processing an invoice of exported products of the invention, a manufacturer is allowed to immediately transmit invoice data of exported products to a forwarder company and a custom broker. This therefore saves time consumed in manual printing and delivering the invoice data of the exported products, and also accelerates processing efficiency for product exportation.

### BRIEF DESCRIPTION OF THE DRAWINGS

The present invention can be more fully understood by reading the following detailed description of the preferred embodiments, with reference made to the accompanying drawings wherein:

FIG. 1 (PRIOR ART) is a schematic diagram depicting a conventional method for processing an invoice of exported products;

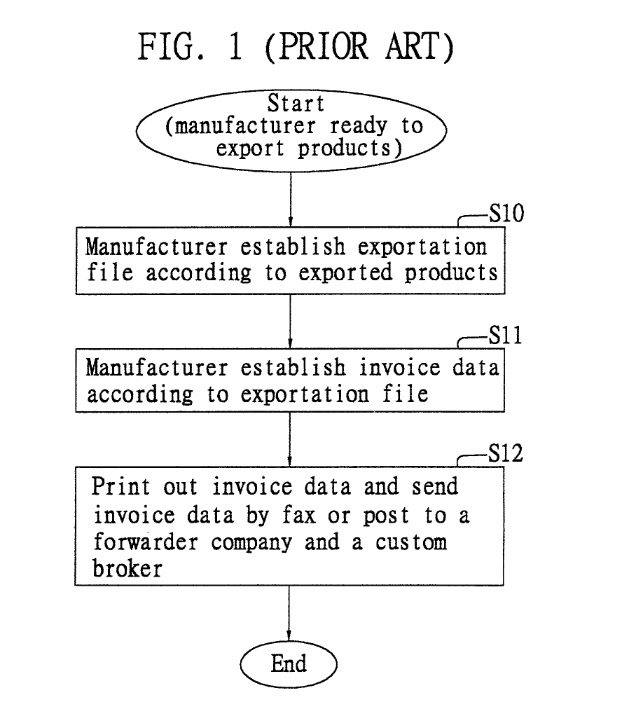

FIG. 2 is a schematic block diagram showing basic architecture of a system for processing an invoice of exported products of the invention; and

FIG. 3 is a schematic diagram depicting a method for processing an invoice of exported products of the invention.

### DETAILED DESCRIPTION OF THE PREFERRED EMBODIMENT

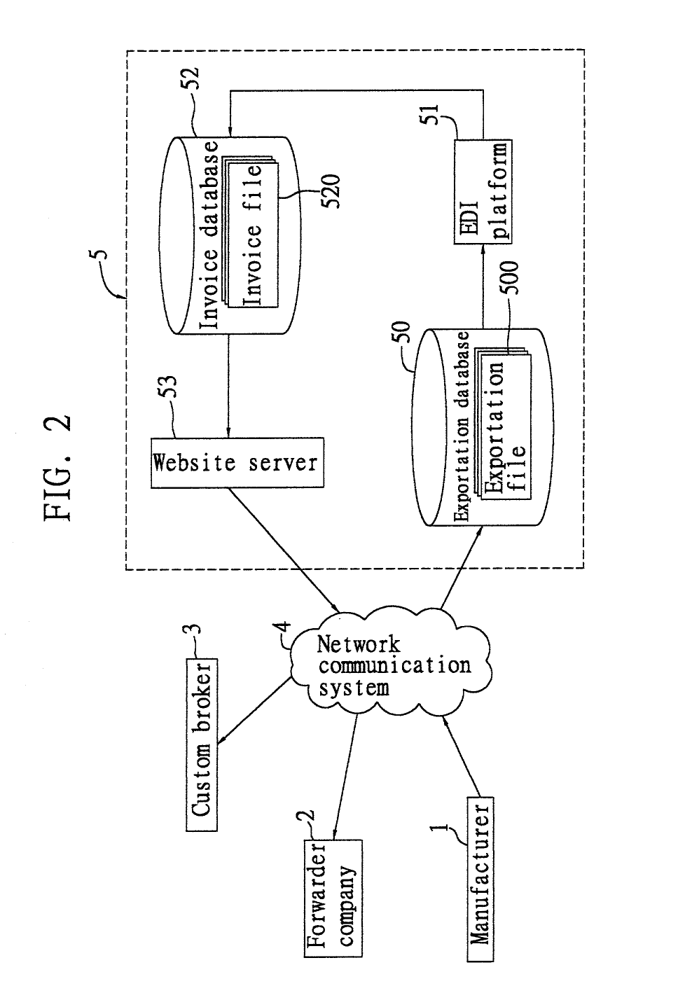

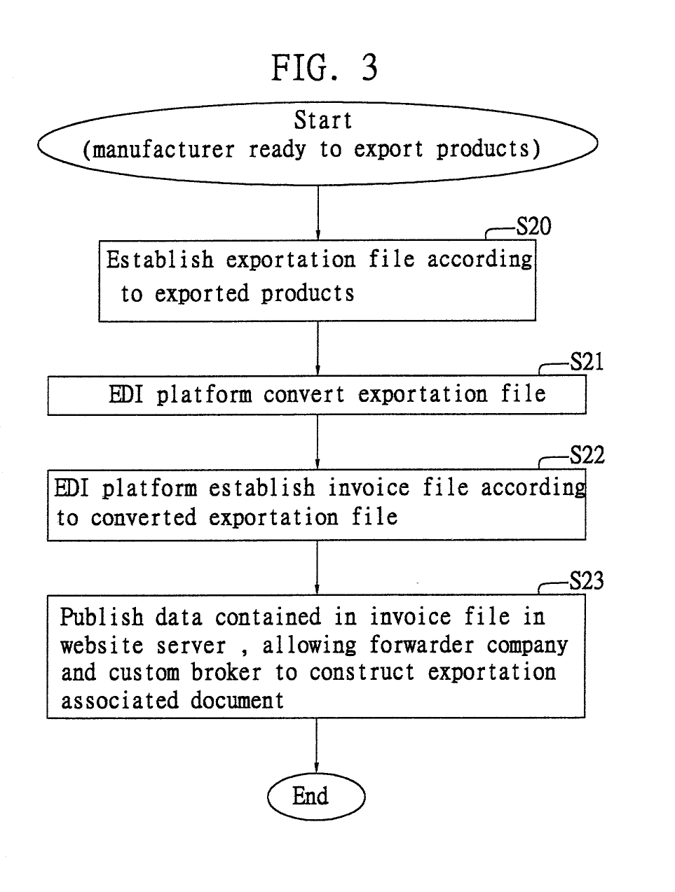

The following description is made with reference to FIGS. 2 and 3 for depicting preferred embodiment of a system and a method for processing an invoice of exported products of the present invention. FIG. 2 illustrates basic architecture of the system for processing an invoice of exported products of the invention; FIG. 3 illustrates the steps involved in the method for processing an invoice of exported products of the invention.

First, referring to FIG. 2, a system for processing an invoice of exported products 5 of the invention (as indicated to be encompassed by dotted lines) is used to allow a manufacturer 1 to establish an invoice data file corresponding to exported products, and immediately transmit the invoice data file through a network communication system 4 (e.g. Internet) to a forwarder company 2 and a custom broker 3, where associated exportation documents for the exported products are constructed. The system for processing an invoice of exported products 5 includes: an exportation database 50, an EDI (electronic data interchange) platform 51, an invoice database 52, and a website server 53.

The exportation database 50 is used to store an exportation data file 500 established by the manufacturer 1 corresponding to exported products in a manner that, the exportation data file 500 is transmitted through the network communication system 4 to be stored in the exportation database 50. The exportation data file 500 is generally in the format of a document file (such as .txt format), which includes exportation associated data such as a registration number of the manufacturer 1, a shipping date, an item quantity, an item unit, a net weight, a total amount of price, a consignee address, a material number, a product quantity, a quantity unit and a unit package quantity, wherein a category number and a serial number of the exported products are taken as an identification number for each record of the exportation data file 500. In product exportation, an exportation workstation (not shown) retrieves the exportation data file 500 from the exportation database 50, and attaches the exportation associated data contained in the exportation data file 500 to the exported products.

The EDI platform 51 is used to convert the exportation data file 500 stored in the exportation database 50 from the document format into web page standard format, and store the converted exportation data file that is assign with an invoice number, an invoice date and a pick-up number, so as to establish a dedicated invoice data file 520 for the exported products according to the assigned data. Since the EDI process is well known in the art of information technology, it is not further described hereinafter.

The invoice database 52 functions to store the invoice data file 520 established by the EDI platform 51. The invoice data file 520 is formed by converting the exportation data file 500 from the original document format into the web page standard format, and includes the data contained in the exportation data file 500 further with the invoice number, the invoice date and the pick-up number for the exported products. Each record of the invoice data file 520 is assigned with a pick-up number, while each pick-up number can correspond to multiple invoice numbers.

The website server 53 is externally connected to the network communication system 4, and internally connected to the invoice database 52, so as to publish the invoice data file 520 stored in the invoice database 52 onto the website server 53, allowing the custom broker 3 and the forwarder company 2 to use a web browser such as Microsoft Internet Explorer or Netscape Navigator for browsing the published invoice data of the exported products on the website server 53 through the network communication system 4. Upon receiving the exported products, the custom broker 3 and the forwarder company 2 can search in the website server 53 for a corresponding invoice data file 520 according to the category number and the serial number of the exportation data attached to the exported products. This allows the forwarder company 2 and the custom broker 3 to be able to conveniently and rapidly construct associated required documents for the exported products.

Referring to both FIGS. 2 and 3, when a manufacturer 1 is ready to export products, first in step S20, the manufacturer 1 establishes an exportation data file 500 corresponding to the exported products, and transmits it through a network communication system 4 to a system for processing an invoice of exported products 5 of the invention. The invoice processing system 5 stores the exportation data file 500 in an exportation database 50. Then, step S21 is proceeded.

In step S21, the invoice processing system 5 transmits the exportation data file 500 to an EDI platform 51, so as to allow the EDI platform 51 to convert the exportation data file 500 from document format into web page standard format to be browsed through a network. Then, step S22 is proceeded.

In step S22, the EDI platform 51 assigns an invoice number, an invoice date and a pick-up number to the converted exportation data file 500, so as to establish an invoice data file 520 dedicated for the exportation data file 500. The invoice processing system 5 stores the invoice data file 520 in an invoice database 52. Then, step S23 is proceeded.

In step S23, the invoice processing system 5 publishes the invoice data file 520 established by the EDI platform 51 onto a website server 53, so as to allow the published invoice data file 520 to be browsed by a forwarder company 2 and a custom broker 3 through a network communication system 4 in the use of a web browser such as Microsoft Internet Explorer or Netscape Navigator.

As compared to the prior art, in the system and method for processing an invoice of exported products of the invention, a manufacturer 1 that is ready to export products is allowed to immediately transmit invoice and packing data of the exported products through a network communication system 4 to a forwarder company 2 and a custom broker 3, so as to construct exportation associated documents. This therefore saves time consumed in invoice data printing and posting, and makes the manufacturer 1 more efficiently interact with the forwarder company 2 and the custom broker 3. In addition, the system and method for processing an invoice of exported products of the invention eliminate the use of manual printing or delivering the invoice and packing data of the exported products, so that the manufacturer 1 can effectively save human resources. Therefore, the invention is more advanced and practicable than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for processing an invoice of exported products, allowing associated data of products exported by a manufacturer to be immediately transmitted to a forwarder company and a custom broker so as to make exportation required documents; the method comprising the steps of:
(1) establishing an exportation data file for exported products via the manufacturer;
(2) converting the exportation data file into web page standard format;
(3) assigning the converted exportation data file with an invoice number, an invoice date and a pick-up number, so as to establish a corresponding invoice data file dedicated for the exported products; and
(4) publishing the invoice data file to a database server, wherein the database server is externally connected to a network communication system, so as to allow the forwarder company and the custom broker to retrieve the invoice data file published on the database server through the network communication system.

2. The method of claim 1, wherein in the step (1), the exportation data file is established as a document file with associated data of the exported products, including a registration number of the manufacturer, a shipping date, an item quantity, an item unit, a net weight, a total amount of price, a consignee address, a material number, a product quantity, a quantity unit and a unit package quantity.

3. The method of claim 1, wherein in the step (2), the exportation data file is converted in format by an EDI (electronic data interchange) platform.

4. The method of claim 1, wherein in the step (4), the network communication system is Internet, and the database server is a website server.

5. A method for processing an invoice of exported products, allowing associated data of products exported by a manufacturer to be immediately transmitted to a forwarder company and a custom broker so as to make exportation required documents; the method comprising the steps of:
(1) establishing an exportation data file for exported products via the manufacturer;
(2) converting the exportation data file into web page standard format via an EDI (electronic data interchange) platform;
(3) assigning the exportation data file converted by the EDI platform with an invoice number, an invoice date and a pick-up number, so as to establish a corresponding invoice data file dedicated for the exported products; and
(4) publishing the invoice data file to a website server, so as to allow the forwarder company and the custom broker to browse the invoice data file published on the website server through Internet.

6. A system for processing an invoice of exported products, allowing associated data of products exported by a manufacturer to be immediately transmitted to a forwarder company and a custom broker so as to make exportation required documents; the system comprising:
an exportation database for storing an exportation data file of exported products established by the manufacturer;
an EDI (electronic data interchange) platform for converting format of the exportation data file stored in the exportation database into web page standard format, and for assigning the converted exportation data file with an invoice number, an invoice date and a pick-up number, so as to establish a corresponding invoice data file;
an invoice database for storing the invoice data file established by the EDI platform; and
a website server for publishing the invoice data file stored in the invoice database to the website server, so as to allow the forwarder company and the custom broker to browse the invoice data file published by the website server through Internet.
